(19) United States
(12) Patent Application Publication
(10) Pub. No.: US 2026/0057334 A1
(43) Pub. Date: Feb. 26, 2026

(54) INFORMATION PROCESSING SYSTEM, INFORMATION PROCESSING METHOD, AND NON-TRANSITORY COMPUTER-READABLE MEDIUM STORING PROGRAM CODE

(71) Applicant: Rakuten Group, Inc., Tokyo (JP)

(72) Inventor: Shunsuke NAKAYAMA, Tokyo (JP)

(73) Assignee: Rakuten Group, Inc., Tokyo (JP)

(21) Appl. No.: 19/297,195

(22) Filed: Aug. 12, 2025

(30) Foreign Application Priority Data
Aug. 23, 2024 (JP) 2024-141974

(51) Int. Cl. G06Q 10/083; G06Q 30/0207

(52) U.S. Cl. CPC G06Q 10/083; G06Q 30/0207

(57) ABSTRACT

An information processing system includes one or more memories configured to store program code and one or more processors. The program code includes product acquisition code configured to cause at least one of the one or more processors to acquire, from a user terminal device, user-selected product data indicating a user-selected product selected as a purchase candidate by a user, packaging form determination code configured to cause the processor to determine a packaging form of the user-selected product, candidates determination code configured to cause the processor to determine whether to include a reward delivery mode in delivery mode candidates for the user-selected product, and registration code configured to cause the processor to register a delivery history of the user-selected product including a delivery mode of the user-selected product.

### CROSS-REFERENCE TO RELATED APPLICATIONS

This application is based upon and claims the benefit of priority from Japanese Patent Application No. 2024-141974, filed on Aug. 23, 2024, the entire contents of which are incorporated herein by reference.

### BACKGROUND

### 1. Field

The present disclosure relates to an information processing system, an information processing method, and a non-transitory computer-readable medium storing program code.

### 2. Description of Related Art

JP2021-26516A discloses a delivery system as an example of an information processing system. The delivery system is configured to, when receiving multiple orders from the same user, determine whether delivering the products collectively or separately is more cost-effective, deliver the products using the selected delivery mode, and provide cashback to the user.

However, in such an information processing system, further improvement in the convenience of the mode of delivering products is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An information processing system according to an aspect of the present disclosure includes one or more memories configured to store program code and one or more processors. The one or more processors are configured to read the program code and operate as instructed by the program code. The program code includes product acquisition code configured to cause at least one of the one or more processors to acquire user-selected product data from a user terminal device, the user-selected product data indicating a user-selected product selected as a purchase candidate by a user. The program code includes packaging form determination code configured to cause at least one of the one or more processors to determine a packaging form of the user-selected product. The program code includes candidates determination code configured to cause at least one of the one or more processors to determine whether to include a reward delivery mode in delivery mode candidates for the user-selected product based on a result of determining the packaging form of the user-selected product, the reward delivery mode granting a reward to the user. The program code includes registration code configured to cause at least one of the one or more processors to register a delivery history of the user-selected product including a delivery mode of the user-selected product. The registration code is configured to cause at least one of the one or more processors to register the delivery history of the user-selected product corresponding to the reward delivery mode as the delivery mode when the reward delivery mode is selected as the delivery mode of the user-selected product by the user. The packaging form determination code is configured to cause at least one of the one or more processors to determine that the packaging form of the user-selected product is compatible with the reward delivery mode when the delivery history of the use-selected product including the reward delivery mode as the delivery mode has been registered. The candidates determination code is configured to cause at least one of the one or more processors to determine the compatibility of the packaging form of the user-selected product with the delivery mode. The candidates determination code is configured to cause at least one of the one or more processors to, based on the determined compatibility, determine to include the reward delivery mode in the delivery mode candidates for the user-selected product when the packaging form is compatible, and determine not to include the reward delivery mode in the delivery mode candidates for the user-selected product when the packaging form is not compatible.

An information processing method according to an aspect of the present disclosure includes acquiring, by at least one of one or more processors, user-selected product data from a user terminal device, the user-selected product data indicating a user-selected product selected as a purchase candidate by a user. The method includes determining, by at least one of the one or more processors, a packaging form of the user-selected product. The method includes determining, by at least one of the one or more processors, whether to include a reward delivery mode in delivery mode candidates for the user-selected product based on a result of determining the packaging form of the user-selected product, the reward delivery mode granting a reward to the user. The method includes registering, by at least one of the one or more processors, a delivery history of the user-selected product including a delivery mode of the user-selected product. The registering a delivery history of the user-selected product includes registering, by at least one of the one or more processors, the delivery history of the user-selected product corresponding to the reward delivery mode as the delivery mode when the reward delivery mode is selected as the delivery mode of the user-selected product by the user. The determining a packaging form of the user-selected product includes determining, by at least one of the one or more processors, that the packaging form of the user-selected product is compatible with the reward delivery mode when the delivery history of the user-selected product including the reward delivery mode as the delivery mode has been registered. The determining whether to include a reward delivery mode in delivery mode candidates for the user-selected product includes determining, by at least one of the one or more processors, the compatibility of the packaging form of the user-selected product with the delivery mode. The determining whether to include a reward delivery mode in delivery mode candidates for the user-selected product includes, based on the determined compatibility, determining, by at least one of the one or more processors, to include the reward delivery mode in the delivery mode candidates for the user-selected product when the packaging form is compatible, and determining not to include the reward delivery mode in the delivery mode candidates for the user-selected product when the packaging form is not compatible.

A non-transitory computer-readable medium according to an aspect of the present disclosure stores program code. The program code includes product acquisition code configured to cause at least one of one or more processors to acquire user-selected product data from a user terminal device, the user-selected product data indicating a user-selected product selected as a purchase candidate by a user. The program code includes packaging form determination code configured to cause at least one of the one or more processors to determine a packaging form of the user-selected product. The program code includes candidates determination code configured to cause at least one of the one or more processors to determine whether to include a reward delivery mode in delivery mode candidates for the user-selected product based on a result of determining the packaging form of the user-selected product, the reward delivery mode granting a reward to the user. The program code includes registration code configured to cause at least one of the one or more processors to register a delivery history of the user-selected product including a delivery mode of the user-selected product. The registration code is configured to cause at least one of the one or more processors to register the delivery history of the user-selected product corresponding to the reward delivery mode as the delivery mode when the reward delivery mode is selected as the delivery mode of the user-selected product by the user. The packaging form determination code is configured to cause at least one of the one or more processors to determine that the packaging form of the user-selected product is compatible with the reward delivery mode when the delivery history of the use-selected product including the reward delivery mode as the delivery mode has been registered. The candidates determination code is configured to cause at least one of the one or more processors to determine the compatibility of the packaging form of the user-selected product with the delivery mode. The candidates determination code is configured to cause at least one of the one or more processors to, based on the determined compatibility, determine to include the reward delivery mode in the delivery mode candidates for the user-selected product when the packaging form is compatible, and determine not to include the reward delivery mode in the delivery mode candidates for the user-selected product when the packaging form is not compatible.

Other features and aspects will be apparent from the following detailed description, the drawings, and the claims.

### BRIEF DESCRIPTION OF THE DRAWINGS

FIG. 1 is a diagram illustrating an overall configuration of an information processing system according to a first embodiment.

FIG. 2 is a diagram illustrating an electrical configuration of the user terminal device in the first embodiment.

FIG. 3 is a diagram illustrating an electrical configuration of the information processing device in the first embodiment.

FIG. 4 is a table illustrating the delivery modes in the first embodiment.

FIG. 5 is a table illustrating a user management database in the first embodiment.

FIG. 6 is a table illustrating a product management database in the first embodiment.

FIG. 7 is a table illustrating a delivery history database in the first embodiment.

FIG. 8 is a flowchart illustrating a delivery process of the first embodiment.

FIG. 9 is a flowchart illustrating a packaging form determination process of the first embodiment.

FIG. 10 is a flowchart illustrating a delivery mode candidate determination process of the first embodiment.

FIG. 11 is a diagram illustrating the display screen of the user terminal device in the first embodiment.

FIG. 12 is a flowchart illustrating a packaging form determination process according to a second embodiment.

FIG. 13 is a flowchart illustrating a delivery mode candidate determination process in the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

An information processing system, an information processing method, and a non-transitory computer-readable medium storing program code according to a first embodiment will now be described.

### Configuration of Information Processing System 10

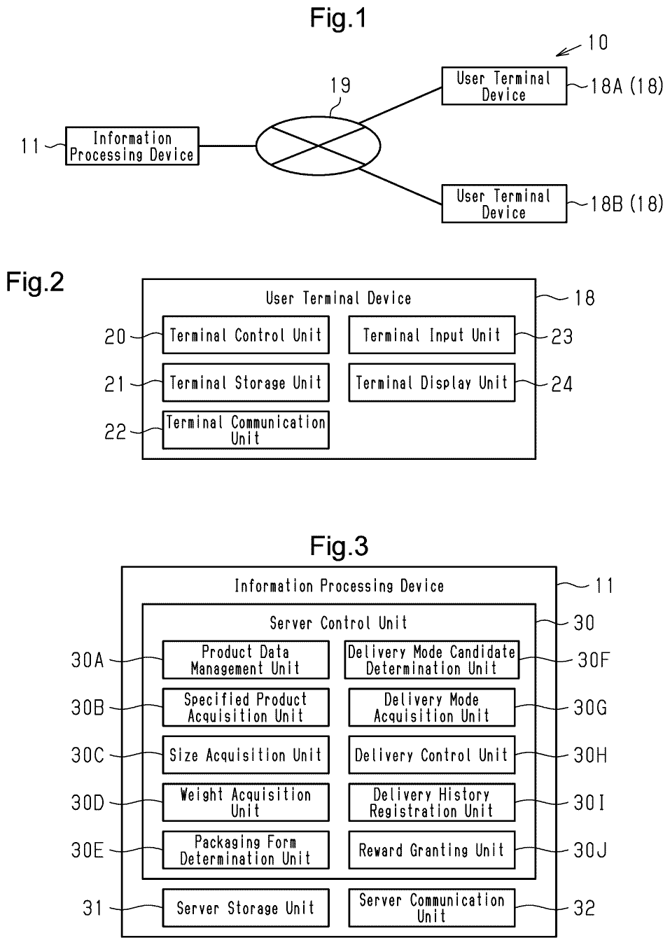

Referring to FIG. 1, an information processing system 10 is configured to provide information to a user. The information processing system 10 is configured to perform control related to services provided to the user.

The information processing system 10 includes an information processing device 11. The information processing device 11 performs control related to information to be provided to the user. The information processing device 11 is managed by the administrator of the information processing device 11.

The information processing device 11 may be a server that provides an electronic commerce (EC) service. The information processing device 11 is, for example, a web server that provides products to the user. The information processing device 11 is configured to manage information related to a product such that the user can browse the information related to the product through a website. The information processing device 11 manages information that has been input by the merchant of a product. The information related to multiple products provided by multiple merchants is posted on the website.

The information processing device 11 is a server that provides a delivery service. The delivery service is offered to deliver user-selected products to the user. The information processing device 11 provides the merchant of a product transacted in an electronic commerce service with data related to the delivery of the product. Accordingly, the merchant delivers a product to the user via a delivery service provider. In this manner, the information processing device 11 may be a server that provides part of the delivery service.

In the present embodiment, examples of products include, but are not limited to, books, magazines, and storage media. Rather, the products may be any product handled in an electronic commerce service. Examples of the storage media may include CDs, DVDs, game software, and computer software.

The information processing system 10 includes a user terminal device 18. The information processing system 10 may include multiple user terminal devices 18A and 18B. The user terminal device 18 may be a portable terminal device that can be carried by the user. The user uses a website and purchases a product.

The information processing device 11 and the user terminal device 18 may be communicable with each other via a network 19. Hereinafter, communication between multiple devices via the network 19 will not be described.

### Configuration of User Terminal Device 18

As shown in FIG. 2, the user terminal device 18 may be implemented by at least one computer. The user terminal device 18 includes a terminal control unit 20, a terminal storage unit 21, a terminal communication unit 22, a terminal input unit 23, and a terminal display unit 24.

The terminal control unit 20 is configured to control the user terminal device 18. The terminal control unit 20 may be implemented as hardware, software, or a combination thereof. The terminal control unit 20 may include a processor. The processor executes instructions in accordance with an operating system (OS) and a program. The processor may be at least one control circuit. The processor may include a central processing unit (CPU), a graphic processing unit (GPU), or a neural network processing unit (NPU). The processor may include an application-specific integrated circuit (ASIC).

The terminal storage unit 21 is a non-transitory computer-readable medium that stores a program. The program may be a dedicated application for using the information processing system 10.

The terminal communication unit 22 is implemented as hardware, software, or a combination thereof. The terminal communication unit 22 sends and receives data to and from the information processing device 11. The terminal input unit 23 is configured to receive information in response to an operation performed by the user. The terminal input unit 23 may be a touch screen integrated with the terminal display unit 24. The terminal input unit 23 may be a pointing device for an operation button. The terminal display unit 24 displays information in response to an output instruction from the terminal control unit 20.

### Configuration of Information Processing Device 11

As illustrated in FIG. 3, the information processing device 11 may be implemented by at least one computer. The information processing device 11 includes a server control unit 30, a server storage unit 31, and a server communication unit 32.

The server control unit 30 is configured to control the information processing device 11. The server control unit 30 may be implemented as hardware, software, or a combination thereof. The server control unit 30 may include a processor. The server control unit 30 has the same configuration as the terminal control unit 20. Thus, the processor will not be described. The server storage unit 31 is a non-transitory computer-readable medium that stores information used to manage the information processing device 11.

The server communication unit 32 is implemented as hardware, software, or a combination thereof. The server communication unit 32 sends and receives data to and from the user terminal device 18. The information processing device 11 may include a server operation unit configured to receive information input by an information provider, or may include a server display unit that displays information.

### Functional Units of Information Processing Device 11

In the information processing device 11, the server control unit 30 may operate as various functional units by executing a program. The server control unit 30 may include a product data management unit 30A, a user-selected product acquisition unit 30B, a size acquisition unit 30C, a weight acquisition unit 30D, a packaging form determination unit 30E, and a delivery mode candidates determination unit 30F. The server control unit 30 may include a delivery mode acquisition unit 30G, a delivery control unit 30H, a delivery history registration unit 30I, and a reward granting unit 30J.

The product data management unit 30A is configured to manage a product handled in an electronic commerce service. The product data management unit 30A manages the size, weight, price, and inventory of the product.

The user-selected product acquisition unit 30B acquires, from the user terminal device 18, user-selected product data selected as a purchase candidate by the user. The user-selected product data indicates at least one product selected as a purchase candidate by the user. Specifically, a product placed in a shopping cart by the user in the electronic commerce service may be an example of a product selected as a purchase candidate by the user. Hereinafter, a product selected as a purchase candidate by the user may be referred to as a user-selected product. A user-selected product may or may not be purchased after being selected as a purchase candidate by the user. A user-selected product is at least one product.

The size acquisition unit 30C is configured to acquire the size of a user-selected product. The size acquisition unit 30C may acquire the size of the user-selected product managed by the product data management unit 30A when the user-selected product acquisition unit 30B acquires the user-selected product data.

The weight acquisition unit 30D is configured to acquire the weight of a user-selected product. The weight acquisition unit 30D may acquire the weight of the user-selected product managed by the product data management unit 30A when the user-selected product acquisition unit 30B acquires the user-selected product data.

The packaging form determination unit 30E is configured to determine the packaging form of a user-selected product. In this specification, the term “packaging form” refers to the external shape, dimensions, weight and packaging state of a product in a condition ready for delivery. The packaging form determination unit 30E may determine whether the packaging form of a user-selected product is compatible with a reward delivery mode, which will be described later. In other words, the packaging form determination unit 30E determines whether the packaging form of a user-selected product is within an allowable range in the restriction on the packaging form defined in the reward delivery mode. For example, the packaging form compatible with the reward delivery mode may be within a range in which a user-selected product can be delivered in the reward delivery mode. For example, the packaging form compatible with the reward delivery mode may allow insertion of a user-selected product into the mailbox at a delivery destination. The packaging form determination unit 30E may determine whether the packaging form of a user-selected product is compatible with the reward delivery mode based on a delivery history. The packaging form determination unit 30E may determine that the packaging form of a user-selected product is compatible with the reward delivery mode when the size of the user-selected product is within the allowable range. The packaging form determination unit 30E may determine that the packaging form of a user-selected product is compatible with the reward delivery mode when the weight of the user-selected product is within the allowable range.

The delivery mode candidates determination unit 30F determines the delivery mode candidates for a user-selected product. The delivery mode candidate is a candidate for a delivery mode that can be selected by the user. The delivery mode is used to deliver a product. The delivery mode is applied to each delivery unit for delivering one or more user-selected products. When multiple user-selected products are delivered collectively, the act of collectively delivering the user-selected products is a delivery unit. When multiple user-selected products are delivered separately, the act of separately delivering each of the user-selected products is a delivery unit.

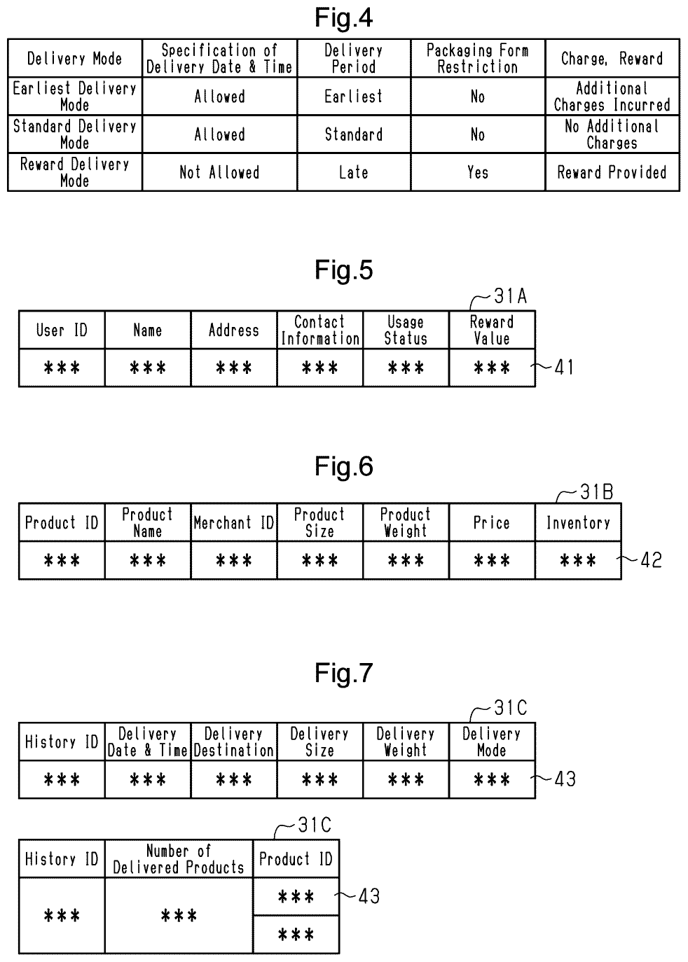

As shown in FIG. 4, the delivery mode may include an earliest delivery mode, a standard delivery mode, and the reward delivery mode. The earliest delivery mode allows the delivery date and time of a user-selected product to be specified. The earliest delivery mode may provide an earlier delivery date and time than the standard delivery mode, and may offer the shortest possible delivery date and time. The earliest delivery mode has no restriction on a packaging form. The restriction on a packaging form requires that the size and weight of a product fall within allowable ranges as the packaging form of the product. The earliest delivery mode may have a higher delivery fee than the standard delivery mode. The earliest delivery mode may incur additional charges.

The standard delivery mode allows the delivery date and time of a user-selected product to be specified. The standard delivery mode has a standard delivery date and time. The standard delivery mode has no restriction on a packaging form. The standard delivery mode does not incur additional charges. In the standard delivery mode, no reward is granted to the user.

The reward delivery mode does not allow the delivery date and time of a user-selected product to be specified. In the reward delivery mode, the delivery date and time is relatively late. The reward delivery mode has a later delivery date and time than the earliest delivery mode and the standard delivery mode. The reward delivery mode has a restriction on a packaging form. The reward delivery mode is selectable when the size and weight of a product fall within allowable ranges as the packaging form of the product. The reward delivery mode may have a lower delivery fee than the standard delivery mode. In the reward delivery mode, a reward is granted to the user.

Whether the size of a product is within the allowable range may be determined by referring to the data indicating the size of the product. Whether the weight of the product is within the allowable range may be determined by referring to the data indicating the weight of the product. Even if the data indicating the size of the product and the data indicating the weight of the product are not referred to, the delivery mode candidates may be determined based on a determination history in which the product was previously determined to be compatible with the reward delivery mode. In this case, the process that acquires the data indicating the size of the product and the data indicating the weight of the product does not have to be executed. This reduces the control load. The data indicating the size of the product and the data indicating the weight of the product do not have to be retained. This reduces the data capacity by the amount corresponding to such data, thereby enabling the determination of whether the reward delivery mode is compatible with a relatively small amount of data.

The reward is a point usable in various services, and may be a coupon usable in various services. The reward value may be the number of points, or may be at least one of a discount amount and a discount rate of the coupon. The coupon may be a discount coupon or a free coupon.

The various services may include an electronic commerce service. The various services may include a delivery service. The various services may include at least one of a reservation service, a video streaming service, and a communication service. The reward may be consumed across multiple services managed by the same manager or across multiple services each managed by a different manager. The reward may be an incentive for the user.

Referring to FIG. 3, the delivery mode candidates determination unit 30F determines the delivery mode candidates for a user-selected product, based on the result of determining the packaging form of the user-selected product by the packaging form determination unit 30E. The delivery mode candidates determination unit 30F determines whether to include the reward delivery mode in the delivery mode candidates for the user-selected product, based on the result of determining the packaging form of the user-selected product by the packaging form determination unit 30E.

In particular, the delivery mode candidates determination unit 30F determines to include the reward delivery mode in the delivery mode candidates for a user-selected product when the packaging form of the user-selected product is compatible with the reward delivery mode. The delivery mode candidates determination unit 30F determines not to include the reward delivery mode in the delivery mode candidates for a user-selected product when the packaging form of the user-selected product is not compatible with the reward delivery mode.

For example, the delivery mode candidates determination unit 30F may determine the delivery mode candidates for a user-selected product based on the delivery history. For example, the delivery mode candidates determination unit 30F may determine the delivery mode candidates for a user-selected product based on the size and weight of the user-selected product. For example, the delivery mode candidates determination unit 30F may determine, based on whether one user-selected product is selected by the user or whether multiple user-selected products are selected by the user, the delivery mode candidates for the user-selected product(s). For example, the delivery mode candidates determination unit 30F may determine the delivery mode candidates for a user-selected product by combining those criteria.

The delivery mode acquisition unit 30G acquires the delivery mode for a user-selected product selected by the user from the user terminal device 18. The delivery control unit 30H performs control related to the delivery of a user-selected product based on the delivery mode for the user-selected product. The delivery history registration unit 30I registers the delivery history of a user-selected product. In particular, the delivery history registration unit 30I registers the acquired delivery mode for a user-selected product as the delivery history of the user-selected product.

The reward granting unit 30J grants a reward to the user. In particular, the reward granting unit 30J grants a reward to the user when the delivery mode for a user-selected product is the reward delivery mode. The reward granting unit 30J may grant a predetermined reward value to the user when the delivery mode for a user-selected product is the reward delivery mode.

### User Management Database 31A

As shown in FIG. 5, the server storage unit 31 stores a user management database 31A. The user management database 31A manages data related to the user. The user management database 31A manages at least one user data table 41.

The user data table 41 includes a user identifier, a name, an address, contact information, a usage status, and a reward value. In the diagram, identifiers are indicated as IDs. In the user data table 41, the user identifier, name, address, contact information, usage status, and reward value are associated with each other.

The usage status may indicate a status in which the electronic commerce service is used. The usage status may be the amount paid by the user in the electronic commerce service. The usage status may be the number of products purchased in the electronic commerce service. The usage status may be the number of times a product has been purchased in the electronic commerce service. The usage status may be the number of views of a website related to a product in the electronic commerce service. The usage status may be a duration of stay on a website related to a product in an electronic commerce service. The usage status may indicate a status in which the delivery service is used. The usage status may indicate a status in which other various services are used. The reward value refers to the value of the reward held by the user.

### Product Management Database 31B

As shown in FIG. 6, the server storage unit 31 stores a product management database 31B. The product management database 31B manages data related to a product in the electronic commerce service. The product management database 31B manages at least one product data table 42.

The product data table 42 includes a product identifier, a product name, a merchant identifier, a product size, a product weight, a product price, and a product inventory. In the product data table 42, the product identifier, product name, merchant identifier, product size, product weight, product price, and product inventory are associated with each other.

### Delivery History Database 31C

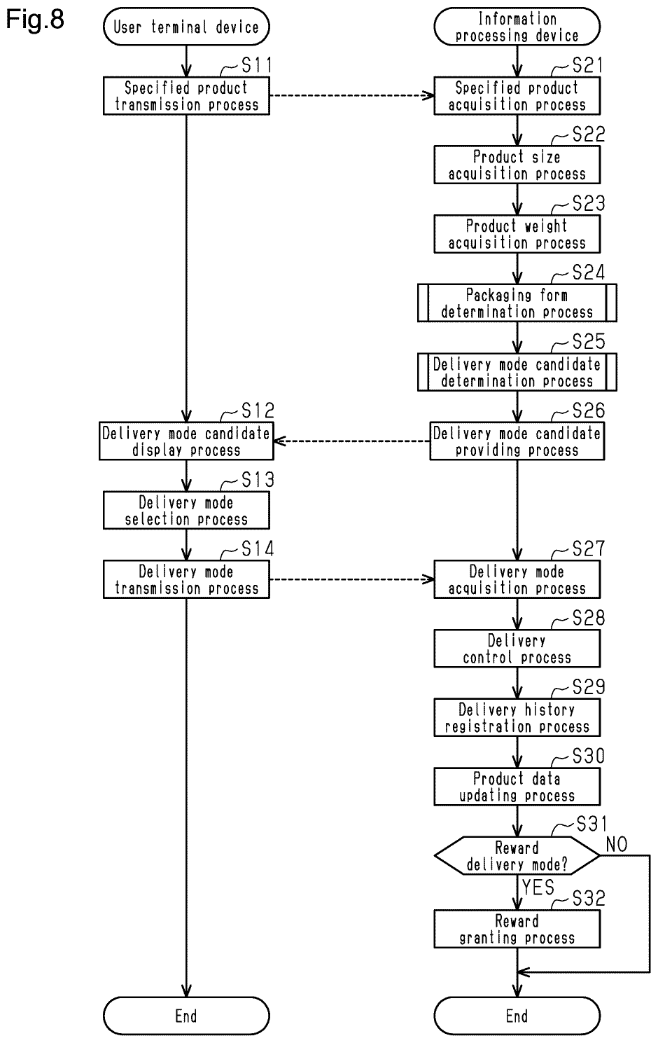

As shown in FIG. 7, the server storage unit 31 stores a delivery history database 31C. The delivery history database 31C manages the delivery history of delivered products. The delivery history database 31C manages at least one delivery history table 43.

The delivery history table 43 includes a history identifier, a delivery date and time, a delivery destination, a delivery size, a delivery weight, a delivery mode, the number of delivered products, and a product identifier. In the delivery history table 43, the history identifier, the delivery date and time, the delivery destination, the delivery size, the delivery weight, the delivery mode, and the number of delivered products are associated with each other. The delivery history table 43 may include a user identifier. In the delivery history table 43, at least one product identifier is associated with one history identifier.

The delivery size is calculated based on the size of one or more user-selected products to be delivered. The delivery size may be the size of one or more user-selected products. The delivery size may be the size of one or more user-selected products in a state in which they are packed and packaged. When there is one user-selected product, the delivery size is calculated based on the size of the one user-selected product to be delivered. When multiple user-selected products are delivered collectively, the delivery size is calculated based on the sizes of the user-selected products to be delivered.

The delivery weight is calculated based on the size of one or more user-selected products. The delivery weight may be the weight of one or more user-selected products. The delivery weight may be the weight of one or more user-selected products in a state in which they are packed and packaged. That is, the delivery weight may include the weights of packing materials and packaging materials.

### Delivery Process

The delivery process will now be described with reference to FIG. 8. The delivery process may include a terminal delivery process executed by the terminal control unit 20 and a server delivery process executed by the server control unit 30.

As shown in FIG. 8, in step S11, the terminal control unit 20 of the user terminal device 18 executes a user-selected product transmission process. In this process, the terminal control unit 20 transmits, as a user-selected product, at least one product selected by the user as a purchase candidate to the information processing device 11.

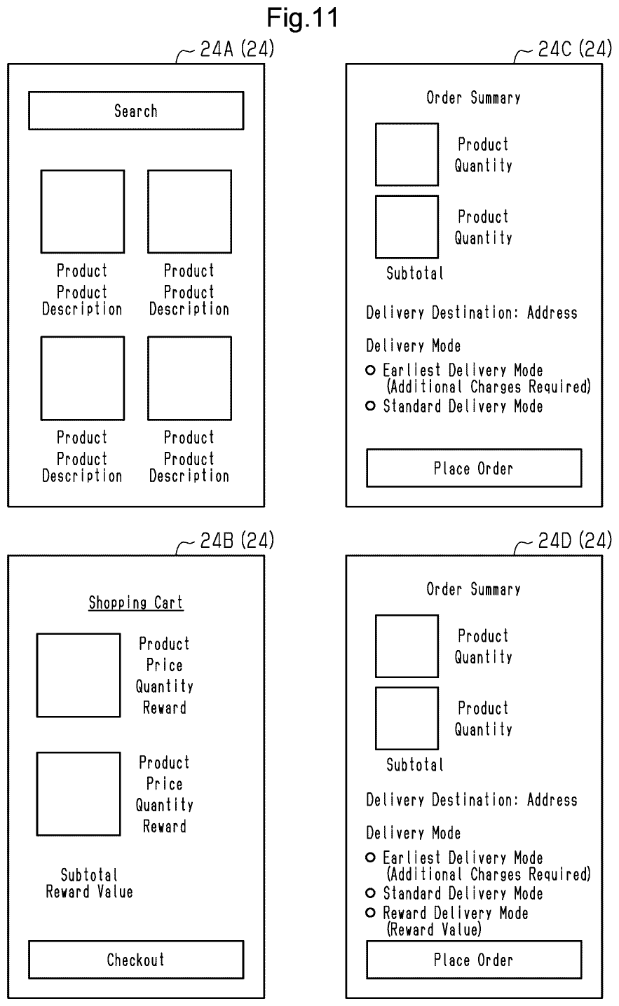

Specifically, as shown in FIG. 11, the terminal control unit 20 causes the terminal display unit 24 to display a first image 24A. The first image 24A is displayed on a website of an electronic commerce service in response to the user's operation. The first image 24A is related to various products. The terminal control unit 20 performs control such that the product selected according to the user's operation is placed in a shopping cart as a purchase candidate.

Next, the terminal control unit 20 causes the terminal display unit 24 to display a second image 24B. The second image 24B is displayed on the website of the electronic commerce service in response to the user's operation. The second image 24B is related to a product placed in a shopping cart. When the checkout button is selected by the user, the terminal control unit 20 transmits, as a user-selected product, at least one product placed in a shopping cart as a purchase candidate to the information processing device 11.

As shown in FIG. 8, in step S21, the server control unit 30 of the information processing device 11 executes a user-selected product acquisition process. In this process, the server control unit 30 receives, from the user terminal device 18, user-selected product data indicating one or more user-selected products selected as purchase candidates by the user. This causes the server control unit 30 to acquire, from the user terminal device 18, user-selected product data indicating one or more user-selected products selected as purchase candidates by the user.

In step S22, the server control unit 30 executes a product size acquisition process. In this process, the server control unit 30 refers to the product management database 31B of the server storage unit 31 to acquire the size of one or more user-selected products. In particular, after acquiring user-selected product data indicating multiple user-selected products in step S21, the server control unit 30 acquires the size of each of the user-selected products.

In step S23, the server control unit 30 executes a product weight acquisition process. In this process, the server control unit 30 refers to the product management database 31B of the server storage unit 31 to acquire the weight of one or more user-selected products. In particular, after acquiring user-selected product data indicating multiple user-selected products in step S21, the server control unit 30 acquires the weight of each of the user-selected products.

In step S24, the server control unit 30 executes a packaging form determination process. As will be described in detail later, in this process, the server control unit 30 determines the packaging form of one or more user-selected products. Specifically, the server control unit 30 determines whether the packaging form of a user-selected product is compatible with the reward delivery mode. In particular, after acquiring user-selected product data indicating multiple user-selected products in step S21, the server control unit 30 determines the packaging form of each of the user-selected products.

In step S25, the server control unit 30 executes a delivery mode candidates determination process. As will be described in detail later, in this process, the server control unit 30 determines the delivery mode candidates for a user-selected product based on the result of determining the packaging form of the user-selected product. In particular, the server control unit 30 determines whether to include the reward delivery mode in the delivery mode candidates for a user-selected product based on the result of determining the packaging form of the user-selected product.

In step S26, the server control unit 30 executes a delivery mode candidates providing process. In this process, the server control unit 30 sends the determined delivery mode candidates to the user terminal device 18. This allows the server control unit 30 to provide the determined delivery mode candidates to the user.

In step S12, the terminal control unit 20 of the user terminal device 18 executes a delivery mode candidates display process. In this process, the terminal control unit 20 causes the terminal display unit 24 to display an image related to the delivery mode candidates received from the information processing device 11.

In step S13, the terminal control unit 20 executes a delivery mode selection process. In this process, the terminal control unit 20 selects one of the delivery mode candidates as the delivery mode according to the user's instruction.

In step S14, the terminal control unit 20 executes a delivery mode transmission process. In this process, the terminal control unit 20 transmits, to the information processing device 11, the delivery mode that has been selected in response to the user's instruction.

Specifically, as shown in FIG. 11, the terminal control unit 20 may cause the terminal display unit 24 to display a third image 24C. The third image 24C displays the earliest delivery mode and the standard delivery mode as delivery mode candidates.

The terminal control unit 20 may cause the terminal display unit 24 to display a fourth image 24D. The fourth image 24D displays the earliest delivery mode, the standard delivery mode, and the reward delivery mode as delivery mode candidates.

When the place-order button is selected with one of the delivery mode candidates selected as the delivery mode according to the user's instruction, the terminal control unit 20 transmits the selected delivery mode to the information processing device 11.

As shown in FIG. 8, in step S27, the server control unit 30 of the information processing device 11 executes a delivery mode acquisition process. In this process, the server control unit 30 receives, from the user terminal device 18, the delivery mode for the user-selected product selected by the user. Accordingly, the server control unit 30 acquires, from the user terminal device 18, the delivery mode for the user-selected product selected by the user. The server control unit 30 may acquire the delivery date and time, the delivery destination, the user identifier, and the payment method of the user-selected product in addition to the delivery mode for the user-selected product from the user terminal device 18.

In step S28, the server control unit 30 executes a delivery control process. In this process, the server control unit 30 performs control related to the delivery of the user-selected product based on the delivery mode for the user-selected product.

Specifically, the server control unit 30 may perform payment for one or more user-selected products based on the price(s) corresponding to the one or more user-selected products. The server control unit 30 may perform payment for one or more user-selected products using the payment method acquired from the user terminal device 18.

When the payment for the user-selected product is successfully completed, the server control unit 30 generates delivery instruction data and sends the delivery instruction data to the merchant corresponding to the user-selected product. The delivery instruction data may include one or more user-selected products and the delivery mode for the user-selected products. The delivery instruction data may include the delivery date and time and the delivery destination. The delivery instruction data may include the user identifier. When the payment for the user-selected product is not successfully completed, the server control unit 30 causes the terminal display unit 24 to display an error image and ends the delivery process.

In step S29, the server control unit 30 executes a delivery history registration process. In this process, the server control unit 30 registers the delivery history of the user-selected product in the delivery history database 31C based on the data acquired from the user terminal device 18.

Specifically, the server control unit 30 generates a history identifier. The server control unit 30 calculates the delivery size based on the size of one or more user-selected products. The server control unit 30 calculates the delivery weight based on the weight of one or more user-selected products. The server control unit 30 acquires the number of delivered user-selected products and the product identifier of one or more user-selected products based on the user-selected products. The server control unit 30 registers the history identifier in the delivery history database 31C of the server storage unit 31 in association with the delivery date and time, the delivery destination, the delivery size, the delivery weight, the delivery mode, and the number of delivered products. The server control unit 30 registers the history identifier and at least one product identifier in the delivery history database 31C of the server storage unit 31 in association with each other.

In step S30, the server control unit 30 executes a product data updating process. In this process, the server control unit 30 updates the product management database 31B so as to subtract the product inventory corresponding to the user-selected product.

In step S31, the server control unit 30 determines whether the delivery mode selected by the user is the reward delivery mode. When determining that the delivery mode selected by the user is not the reward delivery mode, the server control unit 30 ends the server delivery process without executing step S32. When determining that the delivery mode selected by the user is the reward delivery mode, the server control unit 30 proceeds to step S32.

In step S32, the server control unit 30 executes a reward granting process. In this process, the server control unit 30 adds a predetermined reward value to the reward value corresponding to the user identifier. In this manner, when the delivery mode for the user-selected product is the reward delivery mode, the server control unit 30 grants a reward to the user.

### Packaging Form Determination Process

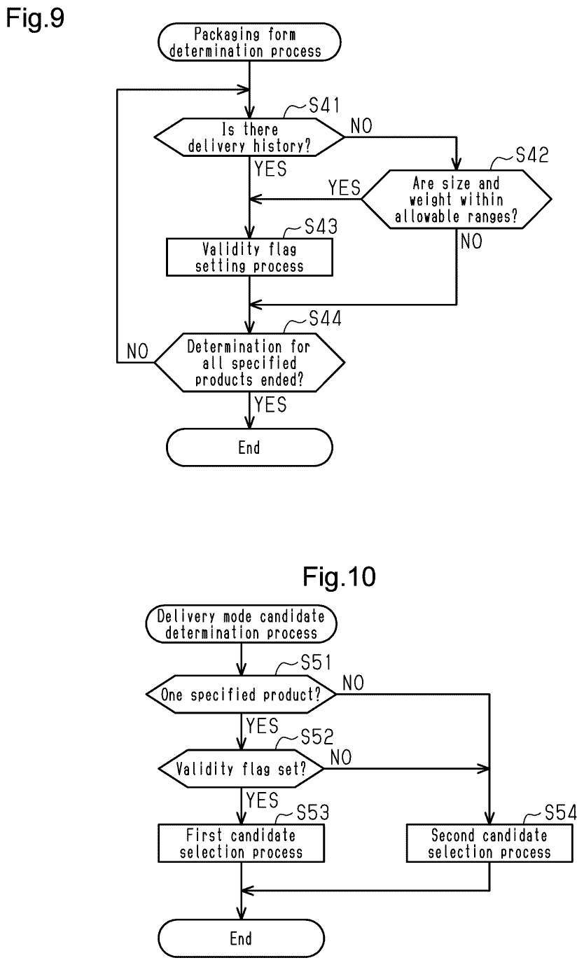

The packaging form determination process executed by the server control unit 30 in step S24 will now be described in detail with reference to FIG. 9.

As shown in FIG. 9, in step S41, the server control unit 30 refers to the delivery history database 31C to determine whether there is a delivery history in which the user-selected product has been delivered in the reward delivery mode. Instead of the delivery history in which the user-selected product has been delivered in the reward delivery mode, the server control unit 30 may determine whether there is a determination history in which the user-selected product has been determined to be delivered in the reward delivery mode. When determining that there is no delivery history in which the user-selected product has been delivered in the reward delivery mode, the server control unit 30 proceeds to step S42. When determining that there is a delivery history in which the user-selected product has been delivered in the reward delivery mode, the server control unit 30 proceeds to step S43.

Referring to FIG. 9, the server control unit 30 may execute both step S41 and step S42 either separately, or may execute step S41 and step S42 in a single combined process. For example, in a case in which only the process consists only of step S41, in step S41, when determining that there is no delivery history in which the user-selected product has been delivered in the reward delivery mode, the server control unit 30 proceeds to step S44. For example, in a case in which the process consists only of step S42, the server control unit 30 starts executing the packaging form determination process from step S42.

In step S42, the server control unit 30 determines whether the size and weight of the user-selected product are within allowable ranges. The server control unit 30 determines that the size and weight of the user-selected product are within the allowable ranges when the size of the user-selected product along three sides is within a predetermined range and the weight of the user-selected product is less than or equal to a predetermined threshold. The size of the user-selected product along the three sides may be based on the length, width, and height of the user-selected product. The predetermined range indicates a packaging form in a range compatible with the reward delivery mode; that is, a packaging form in a range that allows insertion of the user-selected product into the mailbox at the delivery destination.

When determining that the size or weight of the user-selected product is not within the allowable range, the server control unit 30 proceeds to step S44 without executing step S43. When determining that the size and weight of the user-selected product are within the allowable ranges, the server control unit 30 proceeds to step S43.

In step S43, the server control unit 30 executes a validity flag setting process. In this process, the server control unit 30 sets a validity flag for the server storage unit 31 in correspondence with the user-selected product as a result of determining the packaging form of the user-selected product. The validity flag indicates that the packaging form of the user-selected product is compatible with the reward delivery mode.

In step S44, the server control unit 30 determines whether the determination for all the user-selected products included in the user-selected product data acquired in step S21 is completed. When determining that the determination for all the user-selected products is not completed, the server control unit 30 proceeds to step S41 again. In this case, the server control unit 30 determines the packaging form of the next user-selected product. When determining that the determination for all the user-selected products is completed, the server control unit 30 ends the packaging form determination process. In this manner, the server control unit 30 determines the packaging form of all of one or more user-selected products included in the user-selected product data acquired in step S21.

In this manner, the server control unit 30 determines whether the packaging form of the user-selected product is compatible with the reward delivery mode based on the delivery history of the user-selected product. When the size of the user-selected product is within the allowable range, the server control unit 30 determines that the packaging form of the user-selected product is compatible with the reward delivery mode. When the weight of the user-selected product is within the allowable range, the server control unit 30 determines that the packaging form of the user-selected product is compatible with the reward delivery mode.

### Delivery Mode Candidates Determination Process

The delivery mode candidates determination process executed by the server control unit 30 in step S25 will now be described in detail with reference to FIG. 10.

As shown in FIG. 10, in step S51, the server control unit 30 determines whether user-selected product data indicating one user-selected product has been acquired in step S21. In other words, the server control unit 30 determines whether the number of products placed in the shopping cart is one. When determining that user-selected product data indicating multiple user-selected products have been acquired, the server control unit 30 proceeds to step S54. When determining that user-selected product data indicating one user-selected product has been acquired, the server control unit 30 proceeds to step S52.

In step S52, the server control unit 30 determines whether a validity flag has been set in correspondence with one user-selected product. When determining that a validity flag has been set in correspondence with one user-selected product, the server control unit 30 proceeds to step S53. When determining that a validity flag has not been set in correspondence with one user-selected product, the server control unit 30 proceeds to step S54.

In step S53, the server control unit 30 executes a first candidate selection process. In this process, the server control unit 30 selects a first candidate as the delivery mode candidate for the user-selected product. The first candidate is a delivery candidate for one user-selected product. The first candidate includes the earliest delivery mode, the standard delivery mode, and the reward delivery mode.

In this manner, the server control unit 30 determines to include the reward delivery mode in the delivery mode candidates for the user-selected product when the packaging form of the user-selected product is compatible with the reward delivery mode. In particular, when one user-selected product is selected by the user and the packaging form of the one user-selected product is compatible with the reward delivery mode, the server control unit 30 determines to include the reward delivery mode in the delivery mode candidates for the one user-selected product.

Specifically, when there is a delivery history in which the user-selected product has been delivered in the reward delivery mode, the server control unit 30 determines to include the reward delivery mode in the delivery mode candidates for the user-selected product. When the size and the weight of the user-selected product are within the predetermined allowable ranges, the server control unit 30 determines to include the reward delivery mode in the delivery mode candidates for the user-selected product.

In step S54, the server control unit 30 executes a second candidate selection process. In this process, the server control unit 30 selects a second candidate as the delivery mode candidate for the user-selected product. The second candidate is a delivery candidate for one or more user-selected products. The second candidate includes the earliest delivery mode and the standard delivery mode, and does not include the reward delivery mode.

In this manner, when the packaging form of the user-selected product is not compatible with the reward delivery mode, the server control unit 30 determines not to include the reward delivery mode in the delivery mode candidates for the user-selected product. Specifically, when there is no delivery history in which the user-selected product has been delivered in the reward delivery mode and the size or weight of the user-selected product is not within the allowable range, the server control unit 30 determines not to include the reward delivery mode in the delivery mode candidates for the user-selected product. However, this is merely an example. Instead, for example, when there is no delivery history in which the user-selected product has been delivered in the reward delivery mode, the server control unit 30 may determine not to include the reward delivery mode in the delivery mode candidates for the user-selected product. For example, when the size of the user-selected product is not within the allowable range, the server control unit 30 may determine not to include the reward delivery mode in the delivery mode candidates for the user-selected product. For example, when the weight of the user-selected product is not within the allowable range, the server control unit 30 may determine not to include the reward delivery mode in the delivery mode candidates for the user-selected product. For example, when multiple user-selected products are selected by the user, the server control unit 30 determines not to include the reward delivery mode in the delivery mode candidates. For example, a combination thereof may also be used.

### Operation and Advantages of the First Embodiment

The operation and advantages of the first embodiment will now be described.

(1-1) The server control unit 30 determines the packaging form of a user-selected product selected as a purchase candidate by the user. Based on the result of determining the packaging form of the user-selected product, the server control unit 30 determines whether to include the reward delivery mode in the delivery mode candidates for the user-selected product. This configuration allows the reward delivery mode to be selected by the user based on the result of determining the packaging form of the user-selected product. Accordingly, upon purchasing a product, a proper delivery mode candidate is provided to the user based on the packaging form of the user-selected product. Further, the user's awareness of the reward granting is improved. Consequently, convenience of the delivery mode for a product is improved.

(1-2) The server control unit 30 determines to include the reward delivery mode in the delivery mode candidates for a user-selected product when the packaging form of the user-selected product is compatible with the reward delivery mode. The server control unit 30 determines not to include the reward delivery mode in the delivery mode candidates for the user-selected product when the packaging form of the user-selected product is not compatible with the reward delivery mode. This configuration allows the reward delivery mode to be selected by the user when the packaging form of the user-selected product is compatible with the reward delivery mode. Thus, a proper delivery mode candidate is provided to the user based on whether the packaging form of the user-selected product is compatible with the reward delivery mode. For example, the packaging form of the user-selected product compatible with the reward delivery mode may allow insertion of the user-selected product into the mailbox at the delivery destination.

(1-3) The server control unit 30 determines whether the packaging form of a user-selected product is compatible with the reward delivery mode based on the delivery history of the user-selected product. This configuration provides a proper delivery mode candidate to the user based on the delivery history of the user-selected product.

(1-4) When the size of a user-selected product is within an allowable range, the server control unit 30 determines that the packaging form of the user-selected product is compatible with the reward delivery mode. This configuration allows the reward delivery mode to be selected by the user when the size of the user-selected product is within the allowable range. Thus, a proper delivery mode candidate is provided to the user based on whether the size of the user-selected product is within the allowable range.

(1-5) When the weight of a user-selected product is within an allowable range, the server control unit 30 determines that the packaging form of the user-selected product is compatible with the reward delivery mode. This configuration allows the reward delivery mode to be selected by the user when the weight of the user-selected product is within the allowable range. Thus, a proper delivery mode candidate is provided to the user based on whether the weight of the user-selected product is within the allowable range.

(1-6) When one user-selected product is selected by the user and the packaging form of the one user-selected product is compatible with the reward delivery mode, the server control unit 30 determines to include the reward delivery mode in the delivery mode candidates for the one user-selected product. In this configuration, when one user-selected product is selected by the user, the reward delivery mode is allowed to be selected by the user. Thus, a proper delivery mode candidate is provided to the user based on whether one user-selected product has been selected by the user.

(1-7) When multiple user-selected products are selected by the user, the server control unit 30 determines not to include the reward delivery mode in the delivery mode candidates for the user-selected products. In this configuration, when multiple user-selected products are selected by the user, the reward delivery mode is not allowed to be selected by the user. Thus, a proper delivery mode candidate is provided to the user based on whether one user-selected product has been selected by the user.

(1-8) When the delivery mode for a user-selected product selected by the user is the reward delivery mode, the server control unit 30 grants a reward to the user. This configuration improves the user's awareness of the reward granting when purchasing a product.

(1-9) The standard delivery mode allows the delivery date and time of a user-selected product to be specified. The reward delivery mode does not allow the delivery date and time of a user-selected product to be specified. In this configuration, when the reward delivery mode is selected as the delivery mode for the user-selected product, a reward is granted to the user while the delivery date and time of the user-selected product cannot be specified. Thus, a reward is granted to the user, thereby allowing for a time margin before the user-selected product is delivered to the user.

(1-10) The reward delivery mode provides a later delivery date and time of a user-selected product than the standard delivery mode. In this configuration, when the reward delivery mode is selected as the delivery mode for the user-selected product, a reward is granted to the user while the delivery date and time of the user-selected product is relatively late. Thus, a reward is granted to the user, thereby allowing for a time margin before the user-selected product is delivered to the user.

### Second Embodiment

A second embodiment will now be described below. In the description below, the same reference numerals are given to those components that are the same as the corresponding components of the above-described embodiment. Such elements will not be described or will be briefly described.

### Packaging Form Determination Process

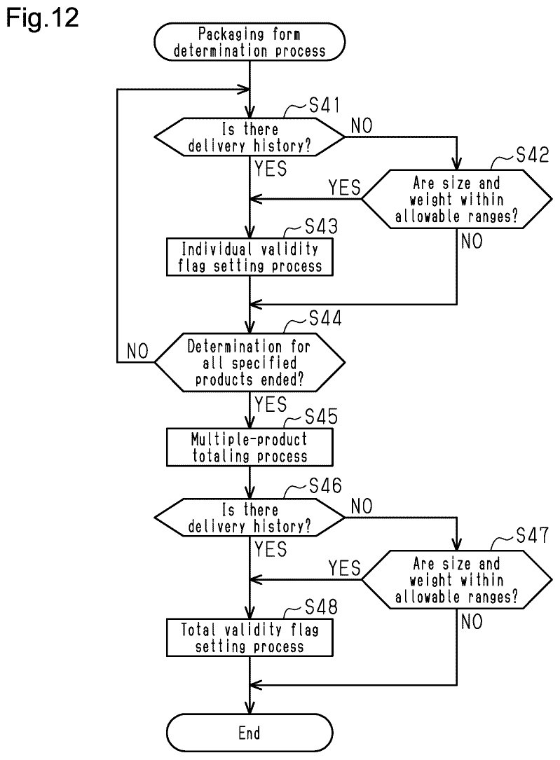

As shown in FIG. 12, in the second embodiment, in step S43 of the packaging form determination process, in the same manner as the first embodiment, the server control unit 30 sets an individual validity flag for the server storage unit 31 in correspondence with the user-selected product as a result of determining the packaging form of the user-selected product. In the same manner as the validity flag of the first embodiment, the individual validity flag of the second embodiment indicates that the packaging form of each of multiple user-selected products is compatible with the reward delivery mode.

In step S44, when determining that the determination for all the user-selected products is completed, the server control unit 30 proceeds to step S45. In step S45, the server control unit 30 executes a multiple-product totaling process. In this process, the server control unit 30 calculates the result of totaling the weights of multiple user-selected products on the assumption that the user-selected products are delivered collectively based on their combined size.

The server control unit 30 calculates the result of totaling the sizes of multiple user-selected products on the assumption that the user-selected products are delivered collectively based on their combined size. For example, for each of the user-selected products, the server control unit 30 allocates the smallest one of the three sides of the user-selected product as the height. The server control unit 30 calculates, as the total size of the user-selected products in the directions corresponding to the lengths and widths of the user-selected products, the maximum size of each user-selected product in those directions. The server control unit 30 calculates, as the total height of the user-selected products, the sum of their heights when stacked vertically.

In step S46, the server control unit 30 determines whether there is a delivery history in which a combination of the user-selected products has been delivered in the reward delivery mode. When determining that there is no delivery history in which a combination of the user-selected products has been delivered in the reward delivery mode, the server control unit 30 proceeds to step S47. When determining that there is a delivery history in which a combination of the user-selected products has been delivered in the reward delivery mode, the server control unit 30 proceeds to step S48.

In step S47, the server control unit 30 determines whether the result of totaling the sizes and weights of the user-selected products calculated in step S45 is within an allowable range. The allowable range is the same in step S42 and step S47.

When determining that the result of totaling the sizes and weights of the user-selected products is not within the allowable range, the server control unit 30 ends the packaging form determination process without executing step S48. When determining that the result of totaling the sizes and weights of the user-selected products is within the allowable range, the server control unit 30 proceeds to step S48.

In step S48, the server control unit 30 executes a total validity flag setting process. In this process, the server control unit 30 sets a total validity flag for the server storage unit 31 in correspondence with multiple user-selected products as a result of determining the packaging form of the user-selected products. The total validity flag indicates that the packaging form of multiple user-selected products are compatible with the reward delivery mode when the user-selected products are delivered collectively.

### Delivery Mode Candidates Determination Process

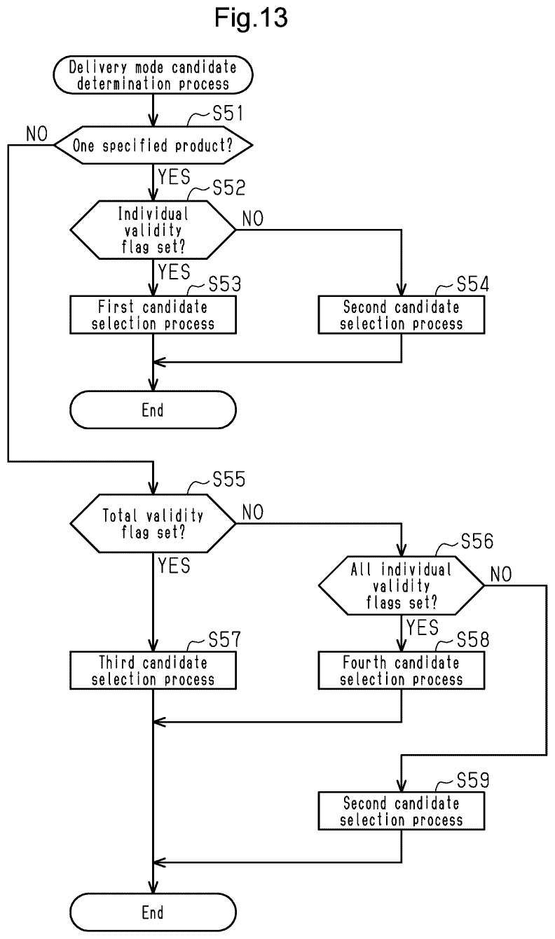

As shown in FIG. 13, in step S51 of the delivery mode candidates determination process, when determining that user-selected product data indicating multiple user-selected products has been acquired, the server control unit 30 proceeds to step S55. In step S55, the server control unit 30 determines whether the total validity flag has been set in correspondence with multiple user-selected products. When determining that the total validity flag has been set in correspondence with multiple user-selected products, the server control unit 30 proceeds to step S57. When determining that the total validity flag has not been set in correspondence with multiple user-selected products, the server control unit 30 proceeds to step S56.

In step S56, the server control unit 30 determines whether the individual validity flag has been set in correspondence with each of all the user-selected products. When determining that the individual validity flag has been set in correspondence with each of all the user-selected products, the server control unit 30 proceeds to step S58. When determining that the individual validity flag has not been set in correspondence with each of all the user-selected products, the server control unit 30 proceeds to step S59.

In step S57, the server control unit 30 executes a third candidate selection process. In this process, the server control unit 30 selects a third candidate as the delivery mode candidate for a user-selected product. The third candidate is a delivery candidate for collectively delivering multiple user-selected products. The third candidate is a delivery candidate for multiple user-selected products. The third candidate includes the earliest delivery mode, the standard delivery mode, and the reward delivery mode.

In this manner, when multiple user-selected products are selected by the user and the packaging form in which multiple user-selected products are packaged is compatible with the reward delivery mode, the server control unit 30 determines to include the reward delivery mode in the delivery mode candidates. The delivery mode candidate corresponds to a delivery mode used when multiple user-selected products are delivered collectively.

In step S58, the server control unit 30 executes a fourth candidate selection process. In this process, the server control unit 30 selects a fourth candidate as the delivery mode candidate for a user-selected product. The fourth candidate is a delivery candidate for multiple user-selected products. The fourth candidate is a delivery candidate for separately delivering each of the user-selected products. The fourth candidate includes the earliest delivery mode and the standard delivery mode, and does not include the reward delivery mode.

In this manner, when multiple user-selected products have been selected by the user and each of the user-selected products is compatible with the reward delivery mode, the server control unit 30 determines to include the reward delivery mode in each of the delivery mode candidates. The delivery mode candidate corresponds to each of the delivery modes used when multiple user-selected products are delivered separately.

In step S59, the server control unit 30 executes the second candidate selection process in the same manner as step S54. In this manner, when multiple user-selected products have been selected by the user and each of the user-selected products is not compatible with the reward delivery mode, the server control unit 30 determines not to include the reward delivery mode in the delivery mode candidates.

### Operation and Advantages of the Second Embodiment

The operation and advantages of the second embodiment will now be described.

(2-1) When multiple user-selected products have been selected by the user, the server control unit 30 determines whether the packaging form in which multiple user-selected products are packaged is compatible with the reward delivery mode. When determining the packaging form in which multiple user-selected products are packaged is compatible with the reward delivery mode, the server control unit 30 determines to include the reward delivery mode in the delivery mode candidates for collective delivery of the user-selected products. In this configuration, even if multiple user-selected products are selected by the user, a proper delivery mode candidate is provided to the user based on the packaging form in which the user-selected products are packaged.

(2-2) When determining each of multiple user-selected products is compatible with the reward delivery mode, the server control unit 30 determines to include the reward delivery mode in the delivery mode candidates for separate delivery of the user-selected products. In this configuration, even if multiple user-selected products are selected by the user, a proper delivery mode candidate is provided to the user based on the packaging form in which each of the user-selected products is delivered separately.

(2-3) When determining each of multiple user-selected products is not compatible with the reward delivery mode, the server control unit 30 determines not to include the reward delivery mode in the delivery mode candidates for separate delivery of the user-selected products. In this configuration, even if multiple user-selected products are selected by the user, a proper delivery mode candidate is provided to the user based on the packaging form in which each of the user-selected products is delivered separately.

### Modifications

The present embodiments may be modified as follows. The present embodiments and the following modifications can be combined if the combined modifications remain technically consistent with each other.

In step S26 of FIG. 8, when there is no inventory of the user-selected product, the server control unit 30 may determine the delivery mode candidates so as not to include the reward delivery mode. Accordingly, if proper delivery of the user-selected product is not ensured, control is performed such that the user does not select the reward delivery mode.

In step S26 of FIG. 8, when the user-selected product is a reserved product, the server control unit 30 may determine the delivery mode candidates so as not to include the reward delivery mode. Accordingly, if proper delivery of the user-selected product is not ensured, control is performed such that the user does not select the reward delivery mode.

In step S32 of FIG. 8, when the delivery mode for the user-selected product is the reward delivery mode, the server control unit 30 may grant a reward for each delivery. Alternatively, when the delivery mode for the user-selected product is the reward delivery mode, the server control unit 30 may grant a reward for each user-selected product.

In step S32 of FIG. 8, when the delivery mode for the user-selected product is the reward delivery mode, the server control unit 30 may provide the user with the reward of a value that is based on the purchase amount of the user-selected product. This improves the awareness of the price of the user-selected product to be purchased.

In step S32 of FIG. 8, when the delivery mode for the user-selected product is the reward delivery mode, the server control unit 30 may provide the user with the reward of a value that is based on the service usage status of the user. This improves the awareness of the service usage status of the user.

The server control unit 30 may update the service usage status of the user based on the activity history of the user. The activity history may include impression (IMP). Impression refers to the number of times a web page has been displayed. The activity history may include a click-through rate (CTR). The click-through rate refers to the ratio of the number of clicks to the number of times a web page has been displayed. The activity history may include conversion (CV). Conversion refers to the number of occurrences of a goal-directed action initiated from a web page. Conversion includes the purchase of a product or service in an electronic commerce service. Conversion includes the reservation of a product or service in a reservation service.

In step S32 of FIG. 8, the server control unit 30 may send, to the terminal device of the merchant, billing data for charging the merchant with the reward value granted to the user. The server control unit 30 may send, to the terminal device of the delivery service provider, billing data for charging the delivery service provider with the reward value granted to the user. The billing data may be part of or all of the reward value granted to the user.

In step S42 of FIGS. 9 and 12 and step S47 of FIG. 12, the server control unit 30 may determine that the size of the user-selected product is within the allowable range when the length of the diagonal line defined by the length and width of the user-selected product and the height of the user-selected product are within a predetermined range.

The server control unit 30 may update the product management database 31B so as to add a new product data table 42 when sales of a product starts. The server control unit 30 may update the product management database 31B so as to add a new product data table 42, as a reserved product, before sales of a product starts.

The server control unit 30 may acquire the size and weight of a product registered in the product management database 31B as the product data table 42 in response to an instruction from the administrator of the information processing device 11. The server control unit 30 may acquire the size and weight of a product registered in the product management database 31B as the product data table 42 in response to an instruction from the merchant of a product. In this case, the server control unit 30 may request, from the merchant of the product, the size and weight of the product registered in the product management database 31B.

The product data table 42 may include a product type. The product type indicates the type of a product. The product type may include, for example, books, daily necessities, and home appliances. The product type may include frozen goods, refrigerated goods, fragile items, and items requiring insurance. The product type corresponds to the product identifier in the product data table 42.

The server control unit 30 may determine whether to include the reward delivery mode in the delivery mode candidates based on the product type corresponding to the user-selected product. For example, when the product type corresponding to the user-selected product is a book, the server control unit 30 may determine whether to include the reward delivery mode in the delivery mode candidates. When the product type corresponding to the user-selected product is a home appliance, the server control unit 30 may determine not to include the reward delivery mode in the delivery mode candidates. When the product type corresponding to the user-selected product is a frozen item, the server control unit 30 may determine not to include the reward delivery mode in the delivery mode candidates.

The product data table 42 may include a delivery base. The delivery base is a location from which a user-selected product is delivered. The delivery base may be, for example, a warehouse in a predetermined area. The delivery base corresponds to the product identifier in the product data table 42.

The server control unit 30 may determine whether to include the reward delivery mode in the delivery mode candidates based on the delivery base corresponding to a user-selected product. For example, when the delivery base corresponding to the user-selected product is a first delivery base, the server control unit 30 may determine whether to include the reward delivery mode in the delivery mode candidates. When the delivery base corresponding to the user-selected product is a second delivery base, the server control unit 30 may determine not to include the reward delivery mode in the delivery mode candidates.

The server control unit 30 may acquire the delivery record of a user-selected product. The delivery record indicates whether the user-selected product has been successfully delivered. The server control unit 30 may acquire the delivery record of the user-selected product from the delivery service provider. The server control unit 30 may register the delivery record of the user-selected product in the delivery history database 31C as the delivery history. In step S41, the server control unit 30 may determine whether there is a delivery history in which the user-selected product has been successfully delivered in the reward delivery mode based on the delivery record of the user-selected product registered in the delivery history database 31C.

The server control unit 30 may determine the packaging form of a user-selected product based on its packaging mode. Specifically, the server control unit 30 acquires, from the user terminal device 18, the packaging mode selected by the user.

The packaging mode includes a standard packaging mode and a special packaging mode. The special packaging mode has a larger delivery size of a user-selected product than the standard packaging mode. For example, the standard packaging mode may be lightweight packaging using wrapping paper or transparent plastic film. For example, the special packaging mode may include wrapping in which the user-selected product is wrapped in a bag or case larger than the user-selected product and provided with a ribbon.

When the packaging mode selected by the user is the standard packaging mode, the server control unit 30 may determine whether to include the reward delivery mode in the delivery mode candidates based on the result of determining the packaging form of the user-selected product. When the packaging mode selected by the user is the special packaging mode, the server control unit 30 may determine not to include the reward delivery mode in the delivery mode candidates.

When the packaging mode selected by the user is the special packaging mode, the server control unit 30 may determine whether to include the reward delivery mode in the delivery mode candidates based on the result of determining the packaging form of the user-selected product on the assumption that the user-selected product is packaged with the special packaging mode.

The server control unit 30 may determine the packaging form of a user-selected product based on the packing mode for the user-selected product. Specifically, the server control unit 30 acquires, from the user terminal device 18, the packing mode selected by the user.

The packing mode includes a standard packing mode and a special packing mode. The special packing mode has a larger delivery size of a user-selected product than the standard packing mode. The standard packing mode may use, for example, a thin cushion material. The special packing mode may use, for example, a thick cushion material having relatively high cushioning properties.

When the packing mode selected by the user is the special packing mode, the server control unit 30 may determine whether to include the reward delivery mode in the delivery mode candidates based on the result of determining the packaging form of the user-selected product on the assumption that the user-selected product is packed in the special packing mode.

When acquiring user-selected product data indicating multiple user-selected products, the server control unit 30 may determine to collectively deliver two or more of multiple user-selected products and separately deliver the remaining user-selected products. In step S45 of FIG. 12, the server control unit 30 may execute the multiple-product totaling process for two or more of the user-selected products. Accordingly, the server control unit 30 may determine whether to collectively deliver two or more user-selected products based on the result of totaling the sizes and weights of the two or more user-selected products.

A user-selected product may be delivered either in a manned or unmanned manner. For unmanned delivery, either an unmanned ground vehicle or an unmanned aerial vehicle may be used. The unmanned aerial vehicle may be a drone.

The delivery mode only needs to include the standard delivery mode and the reward delivery mode, and may include two types or four or more types of delivery modes. The reward delivery mode may include multiple types of delivery modes. That is, the reward delivery mode may include at least one delivery mode.

The server control unit 30 may cause the terminal display unit 24 of the user terminal device 18 to display delivery mode candidates including the reward delivery mode, and may determine whether the reward delivery mode is compatible when the reward delivery mode is selected as the delivery mode by the user. That is, the server control unit 30 may determine whether the reward delivery mode is compatible as the delivery mode for a user-selected product according to the specification by the user, based on the result of determining the packaging form of the user-selected product.

The information processing system 10 may provide a service different from the electronic commerce service and the delivery service. The information processing system 10 may provide, for example, at least one of the reservation service, the video streaming service, and the communication service. The information processing system 10 does not have to provide the electronic commerce service. Various services provided by the information processing system 10 may be managed by the same administrator or by different administrators. In detail, the administrator of the electronic commerce service, the administrator of the delivery service, the merchant of the product, and the delivery service provider may be the same or different entities.

The information processing device 11 may have the configuration of another server. The information processing device 11 may include part of or all of another server that provides, for example, the reservation service, the video streaming service, and the communication service. The information processing device 11 does not have to include part of or all of the electronic commerce server. The information processing device 11 does not have to include part of the delivery service.

The information processing device 11 may include multiple servers. The servers may include, for example, a server that manages data related to the user and a server that performs electronic commerce. The servers may be managed by the same administrator or by different administrators. The information processing system 10 does not have to include the user terminal device 18.

The expression “at least one of” as used herein means “one or multiple” of desired options. For example, the phrase “at least one of” as used herein means only one option if the number of options is two, or both of the two options. As another example, the expression “at least one of” used herein means only one option or a combination of any two or more options if the number of options is three or more.

### CLAUSES

Technical concepts that can be understood from each of the above embodiments and modifications will now be described.

[Clause 1] An information processing system, including:
a user-selected product acquisition unit configured to acquire user-selected product data from a user terminal device, the user-selected product data indicating at least one user-selected product selected as a purchase candidate by a user;
a packaging form determination unit configured to determine a packaging form of the user-selected product; and
a delivery mode candidates determination unit configured to determine whether to include a reward delivery mode in delivery mode candidates for the at least one user-selected product based on a determination result of the packaging form of the user-selected product, where the reward delivery mode grants a reward to the user.

[Clause 2] The information processing system according to clause 1, where
the packaging form determination unit is configured to determine whether the packaging form of the user-selected product is compatible with the reward delivery mode, and
the delivery mode candidates determination unit is configured to:
   determine to include the reward delivery mode in the delivery mode candidates for the user-selected product when the packaging form of the user-selected product is compatible with the reward delivery mode; and
   determine not to include the reward delivery mode in the delivery mode candidates for the user-selected product when the packaging form of the user-selected product is not compatible with the reward delivery mode.

[Clause 3] The information processing system according to clause 2, further including a delivery history registration unit configured to register a delivery history of the user-selected product including a delivery mode for the user-selected product selected by the user, and
the packaging form determination unit is configured to determine that the packaging form of the user-selected product is compatible with the reward delivery mode when the reward delivery mode is registered in the delivery history as the delivery mode for the user-selected product.

[Clause 4] The information processing system according to clause 2 or 3, further including a size acquisition unit configured to acquire a size of the user-selected product, where
the packaging form determination unit is configured to determine that the packaging form of the user-selected product is compatible with the reward delivery mode when the size of the user-selected product is within a predetermined allowable range.

[Clause 5] The information processing system according to any one of clauses 2 to 4, further including a weight acquisition unit configured to acquire a weight of the user-selected product, where
the packaging form determination unit is configured to determine that the packaging form of the user-selected product is compatible with the reward delivery mode when the weight of the user-selected product is within a predetermined allowable range.

[Clause 6] The information processing system according to any one of clauses 2 to 5, further including:
a delivery history registration unit configured to register a delivery history of the user-selected product including a delivery mode for the user-selected product selected by the user;
a size acquisition unit configured to acquire a size of the user-selected product; and
a weight acquisition unit configured to acquire a weight of the user-selected product, where
the packaging form determination unit is configured to determine that the packaging form of the user-selected product is compatible with the reward delivery mode when the reward delivery mode is registered in the delivery history as the delivery mode for the user-selected product or when at least one of the size of the user-selected product and the weight of the user-selected product is within a predetermined allowable range.

[Clause 7] The information processing system according to any one of clauses 2 to 6, where
the delivery mode candidates determination unit is configured to determine to include, when one user-selected product is selected by the user and a packaging form of the one user-selected product is compatible with the reward delivery mode, the reward delivery mode in delivery mode candidates for the one user-selected product.

[Clause 8] The information processing system according to any one of clauses 2 to 7, where
the delivery mode candidates determination unit is configured to determine to include, when multiple user-selected products are selected by the user and a packaging form in which the multiple user-selected products are packaged collectively is compatible with the reward delivery mode, the reward delivery mode in delivery mode candidates for collective delivery of the multiple user-selected products.

[Clause 9] The information processing system according to any one of clauses 2 to 8, where
the delivery mode candidates determination unit is configured to determine to include, when multiple user-selected products are selected by the user and a packaging form of each of the multiple user-selected products is compatible with the reward delivery mode, the reward delivery mode in delivery mode candidates for separate delivery of the multiple user-selected products.

[Clause 10] The information processing system according to any one of clauses 1 to 9, further including:
a delivery mode acquisition unit configured to acquire a delivery mode for the user-selected product selected by the user from the user terminal device; and
a reward granting unit configured to grant a reward to the user when the delivery mode for the user-selected product is the reward delivery mode.

[Clause 11] The information processing system according to clause 10, where
the reward granting unit is configured to grant a reward of a value that is based on a purchase amount of the user-selected product to the user when the delivery mode for the user-selected product is the reward delivery mode.

[Clause 12] The information processing system according to clause 10 or 11, where
the reward granting unit is configured to grant a reward of a value that is based on a service usage status of the user to the user when the delivery mode for the user-selected product is the reward delivery mode.

[Clause 13] The information processing system according to any one of clauses 1 to 12, where
the delivery mode candidates include a standard delivery mode that allows a delivery date and time of the user-selected product to be specified, and the reward delivery mode does not allow the delivery date and time of the user-selected product to be specified.

[Clause 14] The information processing system according to any one of clauses 1 to 13, where
the delivery mode candidates include a standard delivery mode, and
the reward delivery mode provides a later delivery date and time of the user-selected product than the standard delivery mode.

[Clause 15] The information processing system according to any one of clauses 1 to 14, where
the packaging form determination unit is configured to determine whether the packaging form of the user-selected product allows insertion of the user-selected product into a mailbox at a delivery destination, and
the delivery mode candidates determination unit is configured to:
   determine to include the reward delivery mode in the delivery mode candidates for the user-selected product when the packaging form of the user-selected product allows insertion of the user-selected product into the mailbox at the delivery destination; and
   determine not to include the reward delivery mode in the delivery mode candidates for the user-selected product when the packaging form of the user-selected product does not allow insertion of the user-selected product into the mailbox at the delivery destination.

[Clause 16] An information processing device, including:
a user-selected product acquisition unit configured to acquire user-selected product data from a user terminal device, the user-selected product data indicating at least one user-selected product selected as a purchase candidate by a user;
a packaging form determination unit configured to determine a packaging form of the user-selected product; and
a delivery mode candidates determination unit configured to determine whether to include a reward delivery mode in delivery mode candidates for the at least one user-selected product based on a determination result of the packaging form of the user-selected product, where the reward delivery mode grants a reward to the user.

[Clause 17] An information processing method, including:
acquiring, by at least one computer, user-selected product data from a user terminal device, the user-selected product data indicating at least one user-selected product selected as a purchase candidate by a user;
determining, by the at least one computer, a packaging form of the user-selected product; and
determining, by the at least one computer, whether to include a reward delivery mode in delivery mode candidates for the at least one user-selected product based on a result of determining the packaging form of the user-selected product, the reward delivery mode granting a reward to the user.

[Clause 18] A program that causes at least one computer to:
acquire user-selected product data from a user terminal device, the user-selected product data indicating at least one user-selected product selected as a purchase candidate by a user;
determine a packaging form of the user-selected product; and
determine whether to include a reward delivery mode in delivery mode candidates for the at least one user-selected product based on a result of determining the packaging form of the user-selected product, the reward delivery mode granting a reward to the user.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing system, comprising:
one or more memories configured to store program code; and
one or more processors, wherein
the one or more processors are configured to read the program code and operate as instructed by the program code, and
the program code comprises:
product acquisition code configured to cause at least one of the one or more processors to acquire user-selected product data from a user terminal device, the user-selected product data indicating a user-selected product selected as a purchase candidate by a user;
packaging form determination code configured to cause at least one of the one or more processors to determine a packaging form of the user-selected product;
candidates determination code configured to cause at least one of the one or more processors to determine whether to include a reward delivery mode in delivery mode candidates for the user-selected product based on a result of determining the packaging form of the user-selected product, the reward delivery mode granting a reward to the user; and
registration code configured to cause at least one of the one or more processors to register a delivery history of the user-selected product including a delivery mode of the user-selected product,
the registration code is configured to cause at least one of the one or more processors to register the delivery history of the user-selected product corresponding to the reward delivery mode as the delivery mode when the reward delivery mode is selected as the delivery mode of the user-selected product by the user,
the packaging form determination code is configured to cause at least one of the one or more processors to determine that the packaging form of the user-selected product is compatible with the reward delivery mode when the delivery history of the use-selected product including the reward delivery mode as the delivery mode has been registered, and
the candidates determination code is configured to cause at least one of the one or more processors to:
determine the compatibility of the packaging form of the user-selected product with the delivery mode; and
based on the determined compatibility, determine to include the reward delivery mode in the delivery mode candidates for the user-selected product when the packaging form is compatible, and determine not to include the reward delivery mode in the delivery mode candidates for the user-selected product when the packaging form is not compatible.

2. The information processing system according to claim 1, further comprising size acquisition code configured to cause at least one of the one or more processors to acquire a size of the user-selected product, wherein
the packaging form determination code is configured to cause at least one of the one or more processors to determine that the packaging form of the user-selected product is compatible with the reward delivery mode when the size of the user-selected product is within a predetermined allowable range.

3. The information processing system according to claim 1, further comprising weight acquisition code configured to cause at least one of the one or more processors to acquire a weight of the user-selected product, wherein
the packaging form determination code is configured to cause at least one of the one or more processors to determine that the packaging form of the user-selected product is compatible with the reward delivery mode when the weight of the user-selected product is within a predetermined allowable range.

4. The information processing system according to claim 1, further comprising:
size acquisition code configured to cause at least one of the one or more processors to acquire a size of the user-selected product; and
weight acquisition code configured to cause at least one of the one or more processors to acquire a weight of the user-selected product, wherein
the packaging form determination code is configured to cause at least one of the one or more processors to determine that the packaging form of the user-selected product is compatible with the reward delivery mode when at least one of the size and the weight of the user-selected product is within a predetermined allowable range.

5. The information processing system according to claim 1, wherein
the user-selected product is one user-selected product, and
the candidates determination code is configured to cause at least one of the one or more processors to determine to include, when the one user-selected product is selected by the user and a packaging form of the one user-selected product is compatible with the reward delivery mode, the reward delivery mode in delivery mode candidates for the one user-selected product.

6. The information processing system according to claim 5, wherein
the user-selected product is one of multiple user-selected products, and
the candidates determination code is configured to cause at least one of the one or more processors to determine to include, when the multiple user-selected products are selected by the user and a packaging form in which the multiple user-selected products are packaged collectively is compatible with the reward delivery mode, the reward delivery mode in delivery mode candidates for collective delivery of the multiple user-selected products.

7. The information processing system according to claim 6, wherein
the candidates determination code is configured to cause at least one of the one or more processors to calculate, when the multiple user-selected products are selected by the user, a result of totaling sizes of the multiple user-selected products, and determine that the packaging form in which the multiple user-selected products are packaged collectively is compatible with the reward delivery mode when the result of totaling the sizes of the multiple user-selected products is within an allowable range.

8. The information processing system according to claim 6, wherein
the candidates determination code is configured to cause at least one of the one or more processors to calculate, when the multiple user-selected products are selected by the user, a result of totaling weights of the multiple user-selected products, and determine that the packaging form in which the multiple user-selected products are packaged collectively is compatible with the reward delivery mode when the result of totaling the weights of the multiple user-selected products is within an allowable range.

9. The information processing system according to claim 5, wherein
the user-selected product is one of multiple user-selected products, and
the candidates determination code is configured to cause at least one of the one or more processors to determine to include, when the multiple user-selected products are selected by the user and a packaging form of each of the multiple user-selected products is compatible with the reward delivery mode, the reward delivery mode in delivery mode candidates for separate delivery of the multiple user-selected products.

10. The information processing system according to claim 1, further comprising:
delivery mode acquisition code configured to cause at least one of the one or more processors to acquire a delivery mode for the user-selected product selected by the user from the user terminal device; and
granting code configured to cause at least one of the one or more processors to grant a reward to the user when the delivery mode for the user-selected product is the reward delivery mode.

11. The information processing system according to claim 10, wherein
the granting code is configured to cause at least one of the one or more processors to grant a reward of a value that is based on a purchase amount of the user-selected product to the user when the delivery mode for the user-selected product is the reward delivery mode.

12. The information processing system according to claim 10, wherein
the granting code is configured to cause at least one of the one or more processors to grant a reward of a value that is based on a service usage status of the user to the user when the delivery mode for the user-selected product is the reward delivery mode.

13. The information processing system according to claim 1, wherein
the delivery mode candidates include a standard delivery mode that allows a delivery date and time of the user-selected product to be specified, and
the reward delivery mode does not allow the delivery date and time of the user-selected products to be specified.

14. The information processing system according to claim 1, wherein
the delivery mode candidates include a standard delivery mode, and
the reward delivery mode provides a later delivery date and time of the user-selected product than the standard delivery mode.

15. The information processing system according to claim 1, wherein
the packaging form determination code is configured to cause at least one of the one or more processors to determine whether the packaging form of the user-selected product allows insertion of the user-selected product into a mailbox at a delivery destination, and
the candidates determination code is configured to cause at least one of the one or more processors to:
determine to include the reward delivery mode in the delivery mode candidates for the user-selected product when the packaging form of the user-selected product allows insertion of the user-selected product into the mailbox at the delivery destination; and
determine not to include the reward delivery mode in the delivery mode candidates for the user-selected product when the packaging form of the user-selected product does not allow insertion of the user-selected product into the mailbox at the delivery destination.

16. An information processing method, comprising:
acquiring, by at least one of one or more processors, user-selected product data from a user terminal device, the user-selected product data indicating a user-selected product selected as a purchase candidate by a user;
determining, by at least one of the one or more processors, a packaging form of the user-selected product;
determining, by at least one of the one or more processors, whether to include a reward delivery mode in delivery mode candidates for the user-selected product based on a result of determining the packaging form of the user-selected product, the reward delivery mode granting a reward to the user; and
registering, by at least one of the one or more processors, a delivery history of the user-selected product including a delivery mode of the user-selected product,
the registering a delivery history of the user-selected product includes registering, by at least one of the one or more processors, the delivery history of the user-selected product corresponding to the reward delivery mode as the delivery mode when the reward delivery mode is selected as the delivery mode of the user-selected product by the user,
the determining a packaging form of the user-selected product includes determining, by at least one of the one or more processors, that the packaging form of the user-selected product is compatible with the reward delivery mode when the delivery history of the user-selected product including the reward delivery mode as the delivery mode has been registered, and
the determining whether to include a reward delivery mode in delivery mode candidates for the user-selected product includes:
determining, by at least one of the one or more processors, the compatibility of the packaging form of the user-selected product with the delivery mode; and
based on the determined compatibility, determining, by at least one of the one or more processors, to include the reward delivery mode in the delivery mode candidates for the user-selected product when the packaging form is compatible, and determining not to include the reward delivery mode in the delivery mode candidates for the user-selected product when the packaging form is not compatible.

17. A non-transitory computer-readable medium storing program code, the program code comprising:
product acquisition code configured to cause at least one of one or more processors to acquire user-selected product data from a user terminal device, the user-selected product data indicating a user-selected product selected as a purchase candidate by a user;
packaging form determination code configured to cause at least one of the one or more processors to determine a packaging form of the user-selected product;
candidates determination code configured to cause at least one of the one or more processors to determine whether to include a reward delivery mode in delivery mode candidates for the user-selected product based on a result of determining the packaging form of the user-selected product, the reward delivery mode granting a reward to the user; and
registration code configured to cause at least one of the one or more processors to register a delivery history of the user-selected product including a delivery mode of the user-selected product,
the registration code is configured to cause at least one of the one or more processors to register the delivery history of the user-selected product corresponding to the reward delivery mode as the delivery mode when the reward delivery mode is selected as the delivery mode of the user-selected product by the user,
the packaging form determination code is configured to cause at least one of the one or more processors to determine that the packaging form of the user-selected product is compatible with the reward delivery mode when the delivery history of the use-selected product including the reward delivery mode as the delivery mode has been registered, and
the candidates determination code is configured to cause at least one of the one or more processors to:
determine the compatibility of the packaging form of the user-selected product with the delivery mode; and
based on the determined compatibility, determine to include the reward delivery mode in the delivery mode candidates for the user-selected product when the packaging form is compatible, and determine not to include the reward delivery mode in the delivery mode candidates for the user-selected product when the packaging form is not compatible.
